(19) United States
(12) Patent Application Publication
(10) Pub. No.: US 2025/0196624 A1
(43) Pub. Date: Jun. 19, 2025

(54) TOOLBOX SUPPORTING TRANSFER FUEL TANK

(71) Applicant: SuperTanks LLC, Idaho Falls, ID (US)

(72) Inventor: Jonathon W. Barnes, Idaho Falls, ID (US)

(21) Appl. No.: 18/538,602

(22) Filed: Dec. 13, 2023

(51) Int. Cl. B60K 15/077; B29C 33/00; B29D 22/00; B60K 15/03; B60K 15/04

(52) U.S. Cl. CPC B60K 15/077; B29C 33/00; B29D 22/003; B60K 15/04; B60K 2015/03032; B60K 2015/03243; B60K 2015/0344; B60K 2015/0496; B60K 2015/0777

(57) ABSTRACT

A toolbox supporting transfer fuel tank is provided. The transfer fuel tank includes a tank body comprising a vertical portion and a toolbox supporting portion, the tank body having an inner volume, a fill tube coupled to a top surface of the tank body and at least one baffle support extending from a side of the tank body into the inner volume of the tank body. The transfer fuel tank may also include a pickup tube support formed in a bottom surface of the tank body and a strengthening channel formed in the top surface of the tank body to provide rigidity to this area of the tank body to support the transfer pump. The transfer fuel tank may further include at least one lower baffle extending from a rear surface of the tank body and contacting the toolbox supporting portion of the tank body.

### BACKGROUND OF THE INVENTION

### Technical Field

This invention relates generally to a fuel tank and more particularly to a transfer fuel tank for mounting in a truck bed and supporting a toolbox.

### State of the Art

Truck owners often have need for portable liquid storage such as storage for extra fuel, and the like. When the owner needs extra fuel for the truck itself, having a way to store the fuel in the bed of a truck is very convenient. This is typically done by coupling an extra fuel tank within the bed of the truck, wherein the user can access the fuel with a pump and a nozzle to dispense the fuel.

However, the conventional spare fuel tanks have limitations. For example, many conventional spare fuel tanks are limited in size if they are strong or have weaknesses if they are large volume spare fuel tanks. Additionally, the conventional spare fuel tanks may include a transfer pump that is coupled thereto and the conventional spare fuel tanks lack the rigidity to properly support the transfer pump. These tanks also lack other support structures for rigidity and to supporting a pickup tube. Furthermore, the space occupied by conventional tanks makes it difficult to couple other items in the truck bed like a toolbox.

Accordingly, there is a need for a transfer fuel tank for mounting in a truck bed that includes components that provide rigidity that supports the tank structure, supports a transfer pump, and supports a pickup tube, while supporting a toolbox.

### SUMMARY OF THE INVENTION

An embodiment includes a toolbox supporting transfer fuel tank comprising: a tank body comprising a vertical portion and a toolbox supporting portion, the tank body having an inner volume; a fill tube coupled to a top surface of the tank body; a strengthening channel formed in the top surface of the tank body, the strengthening channel is sized and shaped to receive a pipe fitting for a transfer pump, wherein the strengthening channel runs alongside the fitting and the pump to provide rigidity to this area of the tank body to support the transfer pump; and a lower baffle extending from a rear surface of the tank body and contacting the toolbox supporting portion of the tank body adjacent a transition point from the vertical portion to the toolbox supporting portion.

Another embodiment includes a toolbox supporting transfer fuel tank comprising: a tank body comprising a vertical portion and a toolbox supporting portion, the tank body having an inner volume; a fill tube coupled to a top surface of the tank body; at least one baffle support extending from a side of the tank body into the inner volume of the tank body; a pickup tube support formed in a bottom surface of the tank body; a strengthening channel formed in the top surface of the tank body, the strengthening channel is sized and shaped to receive a pipe fitting for a transfer pump, wherein the strengthening channel runs alongside the fitting and the pump to provide rigidity to this area of the tank body to support the transfer pump; and at least one lower baffle extending from a rear surface of the tank body and contacting the toolbox supporting portion of the tank body adjacent a transition point from the vertical portion to the toolbox supporting portion.

Yet another embodiment includes a method of forming a toolbox supporting transfer fuel tank comprising: providing a two-part mold comprising: a first mold part configured to mold a first portion of a vertical portion of a tank body and at least one a lower baffle extending from a rear surface of the vertical portion of the tank body and extends past the parting ling of the two-part mold; and a second mold part configured to mold a second portion of the vertical portion and a toolbox supporting portion of the tank body; molding the tank body wherein the lower baffle contacts a toolbox supporting surface of the toolbox supporting portion of the tank body; and forming a kiss-off between the lower baffle and the toolbox supporting surface as a location adjacent a transition point from the vertical portion to the toolbox supporting portion of the tank body.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1A is a perspective view of a toolbox supporting transfer fuel tank according to an embodiment;

FIG. 1B is a zoomed in partial perspective view of a toolbox supporting transfer fuel tank according to an embodiment;

FIG. 2A is a perspective view of a toolbox supporting transfer fuel tank according to an embodiment;

FIG. 2B is a zoomed in partial perspective view of a toolbox supporting transfer fuel tank according to an embodiment;

FIG. 3A is a perspective view of a toolbox supporting transfer fuel tank according to an embodiment;

FIG. 3B is a zoomed in partial perspective view of a toolbox supporting transfer fuel tank according to an embodiment;

FIG. 3C is a zoomed in partial perspective section view of a toolbox supporting transfer fuel tank according to an embodiment;

FIG. 4A is a perspective view of a toolbox supporting transfer fuel tank according to an embodiment;

FIG. 4B is a zoomed in partial perspective view of a toolbox supporting transfer fuel tank according to an embodiment;

FIG. 5A is a rear view of a toolbox supporting transfer fuel tank according to an embodiment;

FIG. 5B is a zoomed in partial perspective view of a toolbox supporting transfer fuel tank according to an embodiment;

FIG. 6A is a top view of a toolbox supporting transfer fuel tank according to an embodiment;

FIG. 6B is a section view of a toolbox supporting transfer fuel tank taken along section line A-A depicted in FIG. 6A according to an embodiment; and

FIG. 6C is a zoomed view of the section view of FIG. 6B of a toolbox supporting transfer fuel tank according to an embodiment.

### DETAILED DESCRIPTION OF EMBODIMENTS OF THE INVENTION

As discussed above, embodiments of the present invention relate to a transfer fuel tank for mounting in a truck bed that includes components that provide rigidity that supports the tank structure, supports a transfer pump and supports a pickup tube.

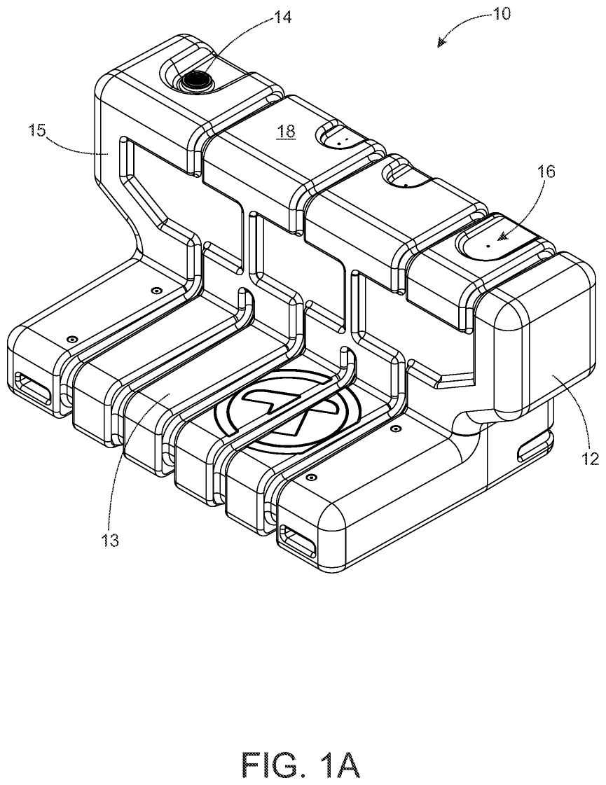

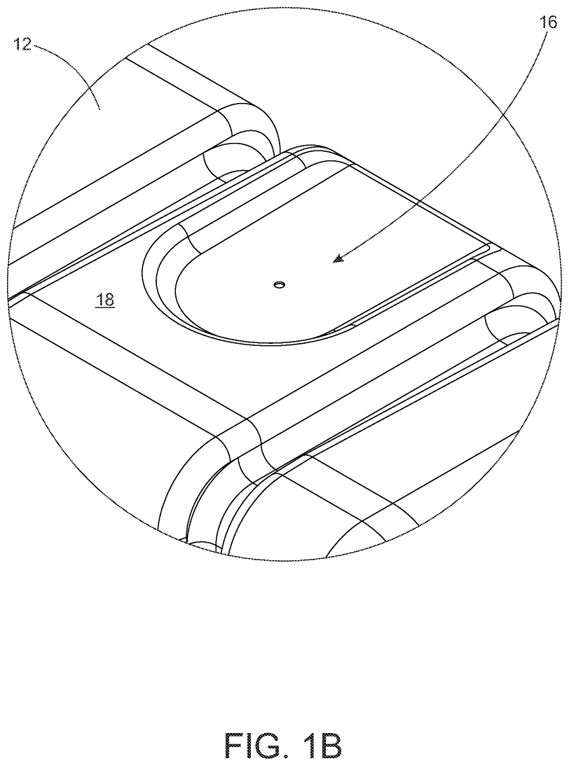

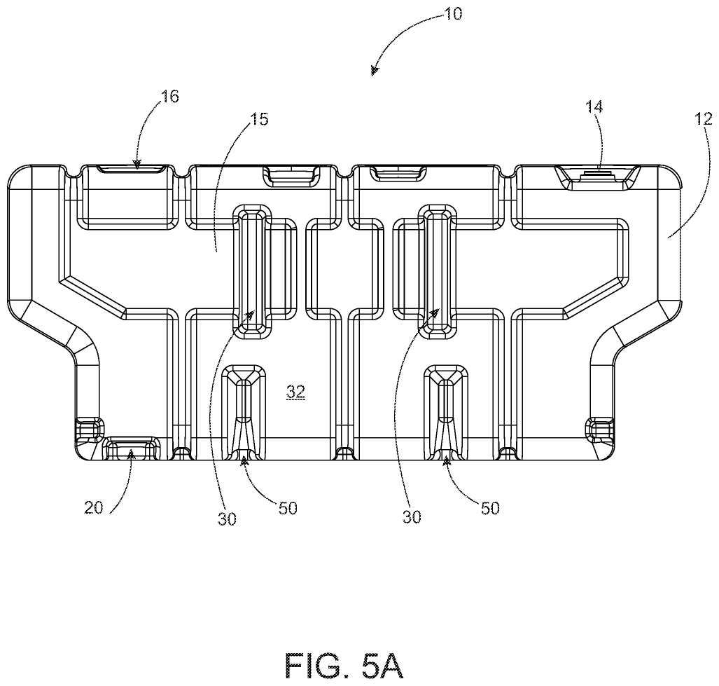

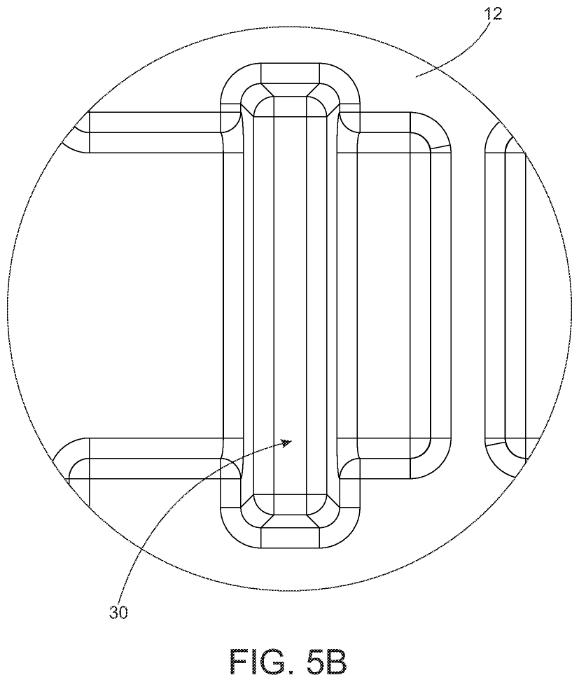

An embodiment of a toolbox supporting transfer fuel tank 10 is depicted in FIGS. 1A-6C. The transfer fuel tank 10 may be formed of a plastic material and may be manufactured through conventional molding processes. Because of the plastic material that the transfer fuel tank 10 is formed of, strength is an important feature of the transfer fuel tank 10. Because of the need for added strength, channels and recesses (not numbered) are located all over a tank body 12 of the transfer fuel tank 10 to provide added support and strength.

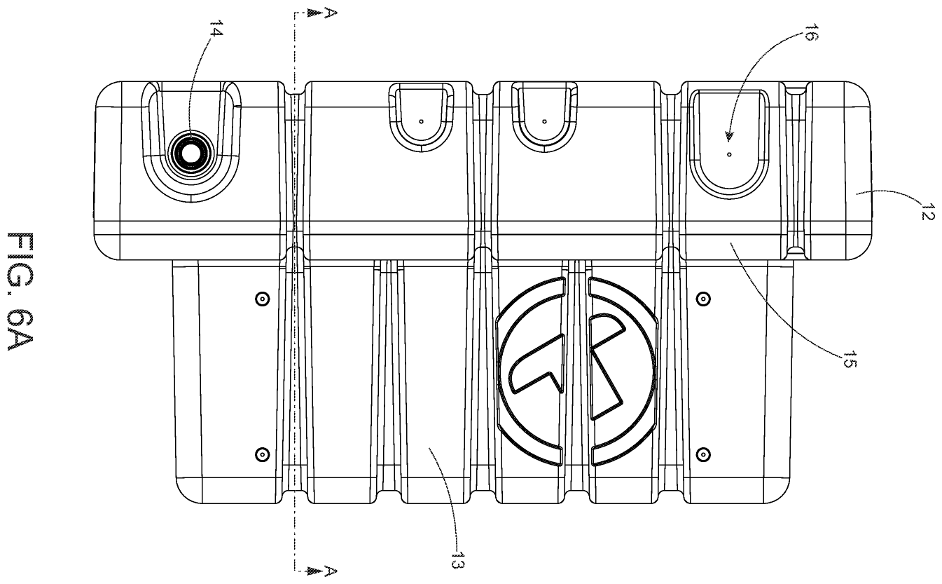

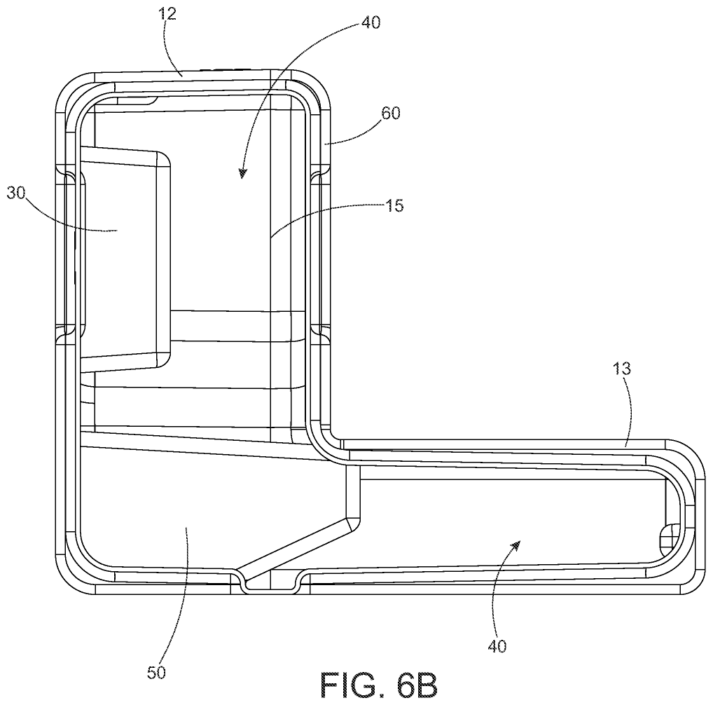

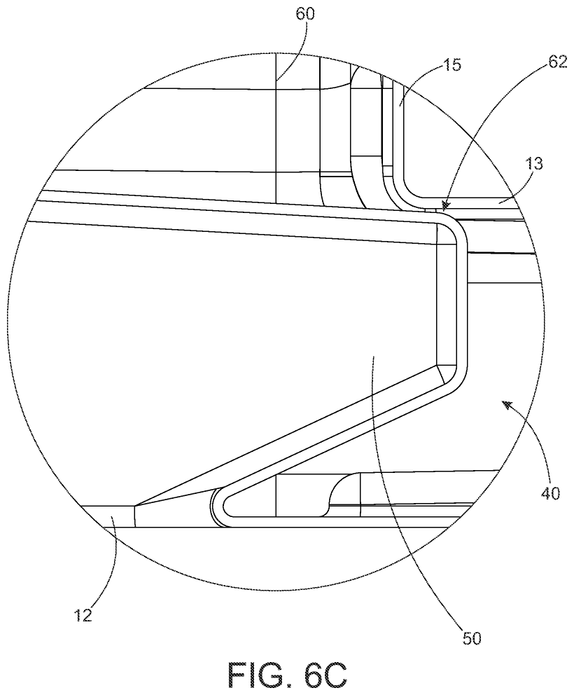

Referring specifically to FIGS. 1A and 1B, the toolbox supporting transfer fuel tank 10 includes a tank body 12 comprising a toolbox supporting portion 13 that extends horizontally from a vertical portion 15. The tank body 12 may further include an inner volume 40 (See FIG. 6), a fill tube 14 and a strengthening channel 16 formed in a top surface 18 of the vertical portion 15 of the tank body 12. The strengthening channel 16 is sized and shaped to receive a pipe fitting, such as, but not limited to a 2-inch National Pipe Taper (“NPT”) fitting for a transfer pump (not shown). This strengthening channel 16 provides added strength that runs alongside the fitting and the pump to provide rigidity to this area of the tank body 12 to better support the transfer pump.

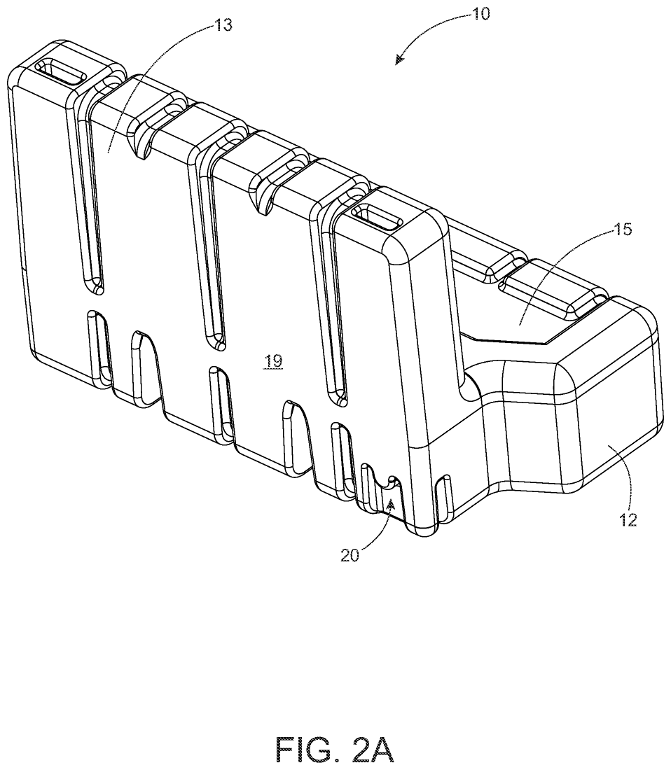

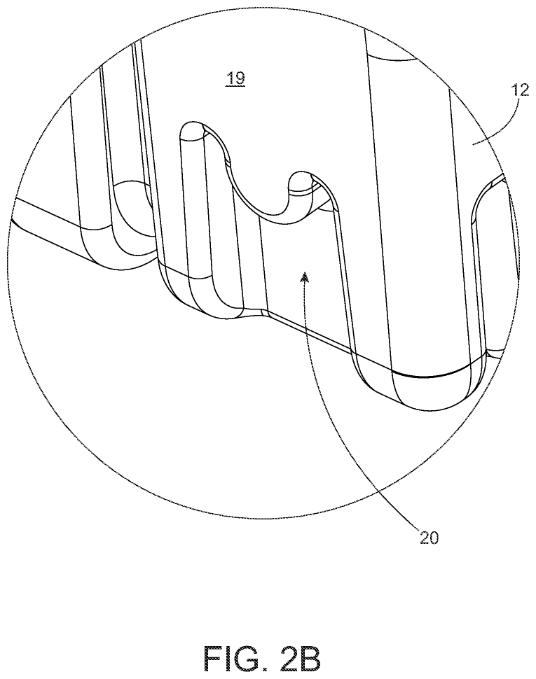

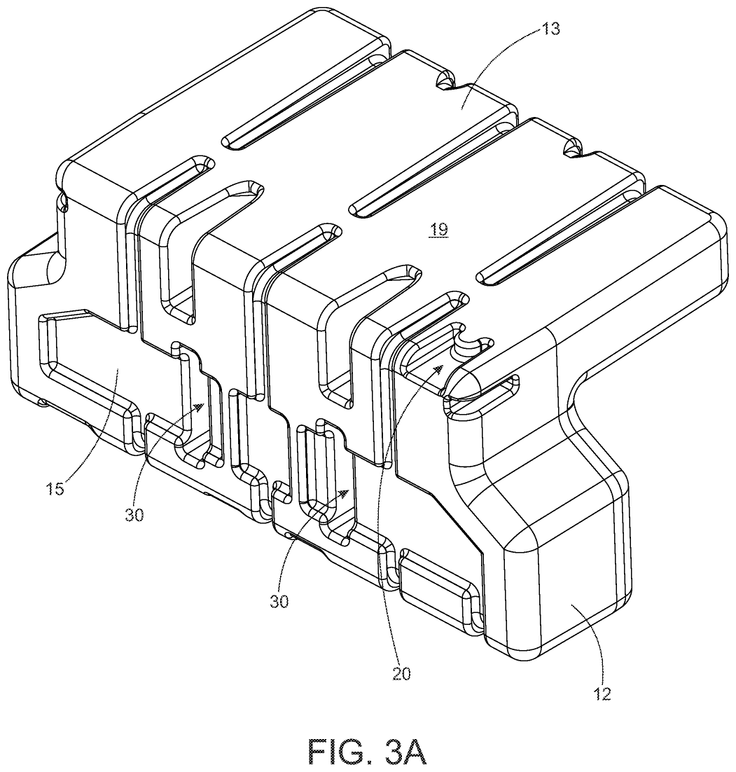

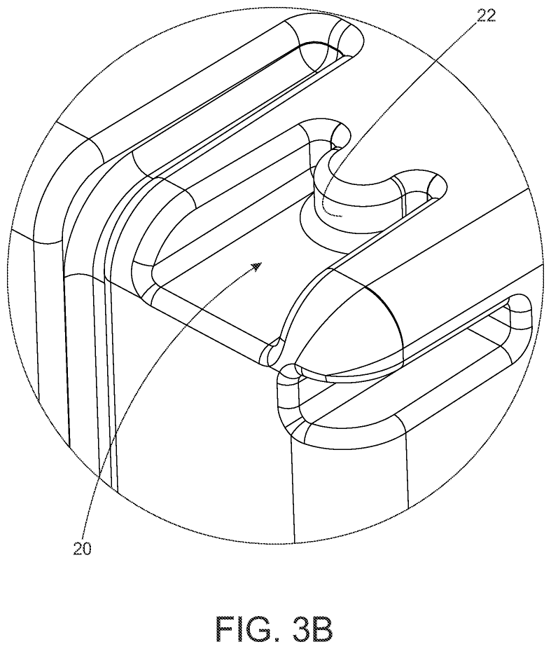

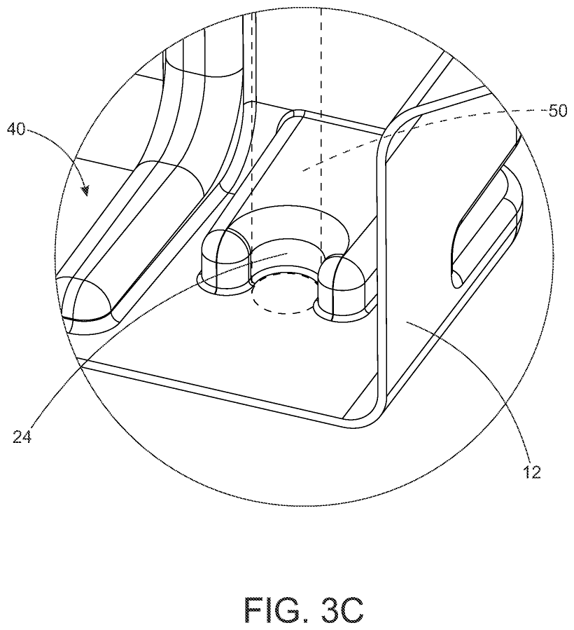

Referring specifically to FIGS. 2A-3C, the tank body 12 may further include a pickup tube recess 20 formed in a bottom surface 19 of the tank body 12. The pickup tube recess 20 includes a rounded end 22 that forms a pickup tube support 24 located on an interior of the tank body 12, as shown in FIG. 3C. In embodiments, as shown, the pickup tube support 24 is a half cylinder. In operation, the pickup tube 50 that is coupled to the transfer pump (not shown) may be received within the pickup tube support 24 and that limits movement of the pickup tube 50 in three directions. Further, the weight of the transfer pump is applied in an axial direction down the pickup tube 50 with the pickup tube support 24 operating to stabilize the transfer pump instead of causing it to vibrate loose as often occurs in conventional fuel tanks.

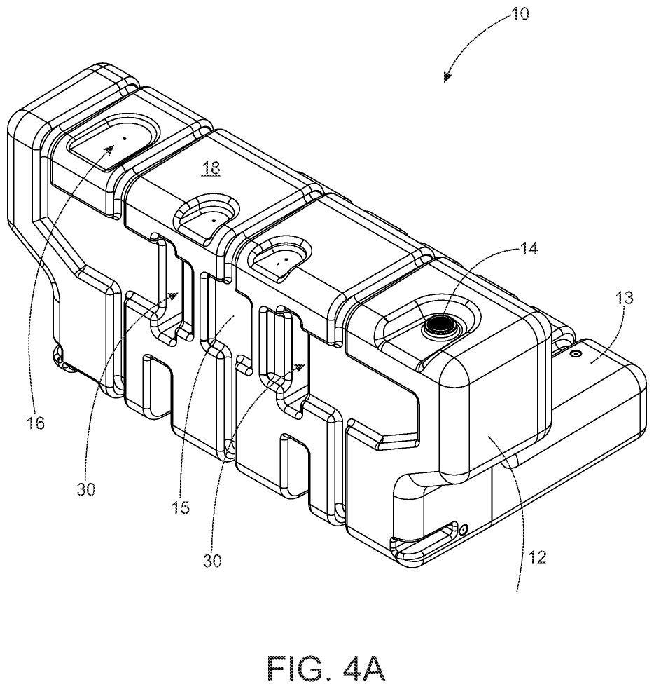

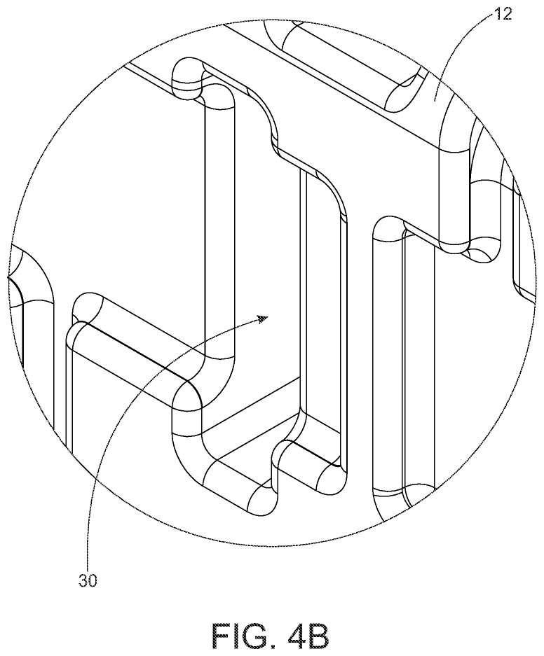

Referring specifically to FIGS. 4A-6C, the tank body includes baffle supports 30. The baffle supports 30 extend from a rear surface 32 of the tank body 12 and into the inner volume 40. The baffle supports 30 are a tapered shape on all sides and extend from a wider opening at the rear surface 32 and a narrower cross-section than the opening at the closed end of the baffle support 30 that is extended within the inner volume 40 of the tank body 12. The baffle supports 30 perform two functions. The first function is to operate as a baffle within the inner volume 40 to inhibit fuel slosh. The second function is to provide additional support as the support features of the tank body 12 are extended across the baffle supports 30 and the tapered shape of the baffle supports 30. These baffle supports 30 are thereby configured to provide a multi-tier support feature that provides increased strength to the tank body 20 over tanks that do not have such baffle supports 30. These baffle supports 30 are in addition to all of the other channels and recesses (not numbered) located all over the tank body 20, these channels and recesses providing support and strength to the overall tank body 12.

In addition to the baffle supports 30, the tank body 12 may include lower baffles 50 that extend from the rear surface 32 of the tank body 12 and contact the toolbox supporting portion 13 of the tank body 12 adjacent a transition point from the vertical portion 15 to the toolbox supporting portion 13 that is designed to hold a toolbox. In embodiments two or more lower baffles 50 may be used to improve the support of the toolbox supporting portion 13. Conventional tanks formed of the same plastic material sag under the weight of the toolbox over time. To avoid this sag, the two uniquely designed lower baffles 50 were incorporated into the tank body 12. During manufacturing of the tank body 12, the lower baffles 50 are purely contained and created by one side of the mold that forms from the rear surface 32. During manufacturing, each lower baffle 50 extends past the parting line 60 to nearly makes contact with a seating surface 17 of the toolbox supporting portion 13, allowing a kiss-off feature 62 to form. The kiss-off feature 62 is a location where the plastic bridges across to solidly mate with the opposite wall, or in other words, the plastic that forms the lower baffle 50 and the seating surface 17 bridges across the gap between the two to solidly mate with each other. These hybrid support lower baffles 50 are unlike anything currently on a product of similar design and material. In addition to the support features of the lower baffles 50, they also function as a baffle to inhibit slosh of fuel within the inner volume 40 of the tank body 12.

Another embodiment includes a method of forming a toolbox supporting transfer fuel tank. The method comprises providing a two-part mold comprising a first mold part configured to mold a first portion of a vertical portion of a tank body and at least one a lower baffle extending from a rear surface of the vertical portion of the tank body and extends past the parting ling of the two-part mold; and a second mold part configured to mold a second portion of the vertical portion and a toolbox supporting portion of the tank body. The method may also include molding the tank body wherein the lower baffle contacts a toolbox supporting surface of the toolbox supporting portion of the tank body; and forming a kiss-off between the lower baffle and the toolbox supporting surface as a location adjacent a transition point from the vertical portion to the toolbox supporting portion of the tank body.

Further the first mold part may be further configured to mold at least one baffle support extending from a rear side of the tank body into the inner volume of the tank body; a pickup tube support formed in a bottom surface of the tank body; and a strengthening channel formed in the top surface of the tank body, the strengthening channel is sized and shaped to receive a pipe fitting for a transfer pump, wherein the strengthening channel runs alongside the fitting and the pump to provide rigidity to this area of the tank body to support the transfer pump.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A toolbox supporting transfer fuel tank comprising:
a tank body comprising a vertical portion and a toolbox supporting portion, the tank body having an inner volume;
a fill tube coupled to a top surface of the tank body;
a strengthening channel formed in the top surface of the tank body, the strengthening channel is sized and shaped to receive a pipe fitting for a transfer pump, wherein the strengthening channel runs alongside the fitting and the pump to provide rigidity to this area of the tank body to support the transfer pump; and
a lower baffle extending from a rear surface of the tank body and contacting the toolbox supporting portion of the tank body adjacent a transition point from the vertical portion to the toolbox supporting portion.

2. The tank of claim 1, further comprising a pickup tube support formed in a bottom surface of the tank body.

3. The tank of claim 2, wherein the pickup tube support is a half cylinder.

4. The tank of claim 3, wherein the pickup tube support receives the pickup tube within the half cylinder and inhibits movement of the pickup tube in at least three directions.

5. The tank of claim 4, wherein the weight of the transfer pump is applied in an axial direction down the pickup tube coupled within the pickup tube support to stabilize the transfer pump and inhibit the transfer pump from vibrating loose.

6. The tank of claim 1, further comprising at least one baffle support extending from a side of the tank body into the inner volume of the tank body.

7. The tank of claim 6, wherein baffle support inhibits fuel slosh of fuel within the inner volume and provides a multi-tier support to the tank body.

8. A toolbox supporting transfer fuel tank comprising:
a tank body comprising a vertical portion and a toolbox supporting portion, the tank body having an inner volume;
a fill tube coupled to a top surface of the tank body;
at least one baffle support extending from a side of the tank body into the inner volume of the tank body;
a pickup tube support formed in a bottom surface of the tank body;
a strengthening channel formed in the top surface of the tank body, the strengthening channel is sized and shaped to receive a pipe fitting for a transfer pump, wherein the strengthening channel runs alongside the fitting and the pump to provide rigidity to this area of the tank body to support the transfer pump; and
at least one lower baffle extending from a rear surface of the tank body and contacting the toolbox supporting portion of the tank body adjacent a transition point from the vertical portion to the toolbox supporting portion.

9. The tank of claim 8, wherein the pickup tube support is a half cylinder.

10. The tank of claim 9, wherein the pickup tube support receives the pickup tube within the half cylinder and inhibits movement of the pickup tube in at least three directions.

11. The tank of claim 10, wherein the weight of the transfer pump is applied in an axial direction down the pickup tube coupled within the pickup tube support to stabilize the transfer pump and inhibit the transfer pump from vibrating loose.

12. The tank of claim 11, wherein baffle support inhibits fuel slosh of fuel within the inner volume and provides a multi-tier support to the tank body.

13. A method of forming a toolbox supporting transfer fuel tank comprising:
providing a two-part mold comprising:
a first mold part configured to mold a first portion of a vertical portion of a tank body and at least one a lower baffle extending from a rear surface of the vertical portion of the tank body and extends past the parting ling of the two-part mold; and
a second mold part configured to mold a second portion of the vertical portion and a toolbox supporting portion of the tank body;
molding the tank body wherein the lower baffle contacts a toolbox supporting surface of the toolbox supporting portion of the tank body; and
forming a kiss-off between the lower baffle and the toolbox supporting surface as a location adjacent a transition point from the vertical portion to the toolbox supporting portion of the tank body.

14. The method of claim 13, wherein the first mold part is further configured to mold at least one baffle support extending from a rear side of the tank body into the inner volume of the tank body; a pickup tube support formed in a bottom surface of the tank body; and a strengthening channel formed in the top surface of the tank body, the strengthening channel is sized and shaped to receive a pipe fitting for a transfer pump, wherein the strengthening channel runs alongside the fitting and the pump to provide rigidity to this area of the tank body to support the transfer pump.
